(19) United States
(12) Patent Application Publication
(10) Pub. No.: US 2025/0075539 A1
(43) Pub. Date: Mar. 6, 2025

(54) CAR TAILGATE HANDLE REINFORCING METHOD AND ITS STRUCTURE

(71) Applicant: HUSHAN AUTOPARTS INC., New Taipei City (TW)

(72) Inventors: Ying-Chih Chen, New Taipei City (TW); Ching-Chiang Tsai, Taipei City (TW); Chang-Sheng Su, Keelung City (TW)

(73) Assignee: HUSHAN AUTOPARTS INC., New Taipei City (TW)

(21) Appl. No.: 18/380,687

(22) Filed: Oct. 17, 2023

(30) Foreign Application Priority Data
Aug. 28, 2023 (TW) 112132391

(51) Int. Cl. E05B 85/10

(52) U.S. Cl. CPC E05B 85/10

(57) ABSTRACT

A method and structure for reinforcing a car tailgate handle is used to strengthen a tailgate handle that is prone to breaking. Through the steps of disassembly, measurement, production of reinforcement parts, assembly of reinforcement parts and original parts, and installation, it is possible to quickly and extensively remedy tailgate handles with mechanical structural defects that have already been sold. This method and structure offer advantages such as simplified design, reduced material usage, environmental friendliness, ease of production, and rapid mass production.

### TECHNICAL FIELD

A method and a structure for reinforcing a car tailgate handle are used for reinforcing a car tailgate handle which is easy to break, in particular to a method and a structure for reinforcing a car tailgate handle which have the advantages of simplifying the structure, reducing the use of materials, being friendly to the environment, being easy to manufacture and being rapidly mass-produced, and being capable of quickly and massively remedying the broken car tailgate handle which has been circulated in the market.

### BACKGROUND

In some commercially available cars, there may be some defects in the design of the car tailgate handle, which makes it easy to break. Although it looks sturdy and durable in appearance, in actual use, the durability of this handle can't match the customer's usage habits.

First of all, there may be a problem of insufficient mechanical strength in the design. In some commercially available cars, the design of the car tailgate handle seems to ignore the actual use habits of customers and lacks sufficient durability. The designer pays attention to details in appearance and adopts a gorgeous metal shell, giving people a strong and durable impression. However, in actual use, these handles are often unable to meet the needs of customers. The material used for the handlebars may be too fragile to withstand the pressure under normal use. Car owners often need to pull the car tailgate hard. When this material lacks sufficient strength, it is easy to break after a period of use.

In addition, there may be structural defects in the design of the handle. The stress area of some handle locking structures is too small, which does not meet the stress area of the owner when opening the car tailgate, resulting in a slight crack in the car tailgate handle from the locking point, which will further accelerate the fracture of the handle.

In a word, the design of the car tailgate handle of the car on the market is different from the actual use habits of customers, the fragility of materials, the design with too small stress area and the habit of frequent use of the car tailgate by car owners, which may cause the handle to break easily, and it often takes three to five years for car manufacturers to accumulate enough consumer feedback to produce improved car tailgate handle parts, which will bring inconvenience and maintenance costs to car owners.

In terms of maintenance, plastic-steel soil is usually used for gap filling and adhesion, which is not only unsightly, but also likely to break repeatedly. Another maintenance method is to continuously replace parts with poor design, which can't really solve the problem and waste resources. Another one is to make a complete copy of the car tailgate handle with stronger mechanical strength. Although it can be done once and for all, its production cost is high, the mold making is relatively difficult, the structure is more complicated, and the general car tailgate has a lock.

### SUMMARY

In order to solve the above problems, the present invention relates to a method for reinforcing a car tailgate handle, which is used to reinforce an easily broken car tailgate handle. Two supporting posts are protruded on the car tailgate handle, and the ends of the supporting posts are provided with keyhole contact surfaces, and a keyhole is formed on the keyhole contact surface. The method for reinforcing a car tailgate handle comprises the following steps:
S1 a disassembling step: disassembling the car tailgate handle;
S2: a measuring step: precisely measuring a each keyhole contact surface that is easy to break of the car tailgate handle, the position of each keyhole and the three-dimensional shape data of each part in the shortest linear distance between the supporting posts;
S3, a manufacturing step: copying and manufacturing a completely corresponding reinforcement structure according to the three-dimensional shape data, wherein the reinforcement structure has a reinforcement structure body, the shape of one side of the reinforcement structure body is consistent with the shape of the car tailgate handle between the supporting posts, and two ends of the other side of the reinforcement structure body are convexly provided with reinforcing supporting posts, and the shape of one side of the reinforcing supporting posts is consistent with the shape of one side of the supporting posts; the top ends of the reinforcing supporting posts are provided with reinforcing keyhole contact surfaces whose shape matches that of the keyhole contact surface, and the reinforcing keyhole contact surfaces are provided with reinforcing keyholes completely corresponding to the positions of the keyholes, and the car tailgate handle reinforcement structure can be attached between the two supporting posts.
S4, a combining step: tightly bonding the reinforcement structure with the car tailgate handle, wherein the reinforcing keyhole contact surfaces are closely bonded with the keyhole contact surfaces, and the reinforcement structure body is closely bonded with the car tailgate handle between the keyholes to form a reinforced car tailgate handle.
S5, an installation step: installing the reinforced car tailgate handle back to the car tailgate, and the sides of the reinforcing keyhole contact surfaces facing the car body are locked on the car tailgate.

In addition, the structure of the present invention is a car tailgate handle reinforcement structure, which is used to reinforce an easily broken car tailgate handle. Two supporting posts are protruded on the car tailgate handle, and the ends of the supporting posts are provided with a keyhole contact surface, and a keyhole is formed on the keyhole contact surfaces. The car tailgate handle reinforcement structure is characterized in that:
the car tailgate handle reinforcement structure has a reinforcement structure body, the shape of one surface of the reinforcement structure body is consistent with the shape of the car tailgate handle between the supporting posts, two ends of the other surface of the reinforcement structure body are provided with reinforcing supporting posts, the shape of one side surface of the reinforcing supporting posts is consistent with the shape of one side surface of the supporting posts, the top ends of the reinforcing supporting posts are provided with a reinforcing keyhole contact surface whose shape is consistent with the shape of the keyhole contact surface, and the reinforcing keyhole contact surfaces are provided with reinforcing keyholes completely corresponding to the positions of the keyholes, and the car tailgate handle reinforcement structure can be attached between the two supporting posts.

The main technical means of this creation is to directly copy and manufacture a reinforcement structure with the shortest linear distance by accurately measuring the each keyhole contact surface, the position of each keyhole and the distance between the supporting posts of the car tailgate handle. The reinforcement structure can be manufactured by injection molding, manufacturing, stamping, CNC cutting and 3D printing. The car tailgate handle reinforcement structure is produced according to the requirements of products. The car tailgate handle reinforcement structure at least comprises a reinforcement structure body, the shape of one side of the reinforcement structure body is consistent with the shape of the car tailgate handle between the supporting posts, and two ends of the other side of the reinforcement structure body are convexly provided with reinforcing supporting posts, and the shape of one side of the reinforcing supporting posts is consistent with the shape of one side of the supporting posts. The top ends of the reinforcing supporting posts are provided with a reinforcing keyhole contact surface whose shape matches that of the keyhole contact surface, and the reinforcing keyhole contact surfaces are provided with reinforcing keyholes completely corresponding to the positions of the keyholes, and the car tailgate handle reinforcement structure can be attached between the two supporting posts.

In this way, the car tailgate handle reinforcement structure with the lowest manufacturing cost can be obtained, and a completely copied car tailgate handle can be produced with stronger materials without re-molding, so that the reinforced method and structure of the car tailgate handle have the advantages of simplified structure, reduced material use, friendliness to environment, easy manufacture and rapid mass production, and can quickly and massively remedy the car models that have already circulated the car tailgate handle and are easy to break.

The secondary technical means of the present invention is that the structure comprises reinforcing supporting posts and the shape of one side of the reinforcing supporting posts is consistent with that of one side of the supporting posts, and the top ends of the reinforcing supporting posts are provided with a reinforcing keyhole contact surface whose shape is consistent with that of the keyhole contact surface, and the reinforcing keyhole contact surfaces are provided with reinforcing keyholes completely corresponding to those of the keyhole positions, so that the problem of poor design of the original car tailgate handle with too small stress area can be solved, and the mechanical strength of the stress surface of the original car tailgate handle can be enhanced by increasing the thickness. The reinforcement structure of the car tailgate handle can be made of plastic steel or metal.

### BRIEF DESCRIPTION OF DRAWINGS

FIG. 1 is an embodiment of the present invention;

FIG. 2 is an action diagram of step S4 and step S5 of the present invention; and

FIG. 3 is a step diagram of the method of the present invention.

### DESCRIPTION OF EMBODIMENTS

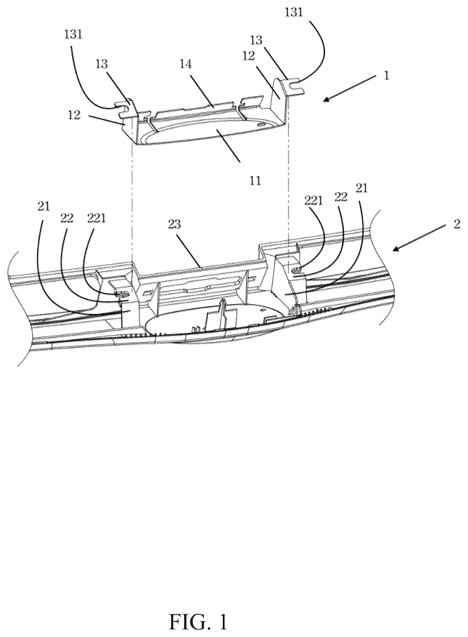

Please refer to FIG. 1, which is an implementation diagram of the present invention, which discloses the present invention. A car tailgate handle reinforcement structure is used to reinforce an easily broken car tailgate handle. Two supporting posts are protruded on the car tailgate handle, and the ends of the supporting posts are provided with keyhole contact surfaces, and the keyhole contact surfaces are provided with keyholes. The car tailgate handle reinforcement structure is characterized in that the car tailgate handle reinforcement structure has a reinforcement structure body, the shape of one side of the reinforcement structure body matches the shape of the car tailgate handle between the supporting posts, and two ends of the other side of the reinforcement structure body are provided with reinforcing supporting posts, one side of which matches the shape of one side of the supporting posts, and the top ends of the reinforcing supporting posts are provided with a reinforcing keyhole contact surface whose shape matches the shape of the keyhole contact surface. The contact surfaces of the reinforcing keyholes are provided with reinforcing keyholes corresponding to the positions of the keyholes, and the reinforcement structure of the car tailgate handle can be attached between the two supporting posts.

This figure reveals that the reinforcement structure of the car tailgate handle is copied from the shape between the two keyholes of the car tailgate handle, instead of copying the whole car tailgate handle, so that it is unnecessary to make a mold for the whole car tailgate handle, and the whole structure is quite simple, which can reduce the material and cost, and can continue to use the old car tailgate handle and enhance the mechanical strength of the car tailgate handle.

In addition, the figure also reveals that the tailgate handle is further provided with a lock seat at an appropriate position adjacent to the two supporting posts, and the reinforcement structure body of the present invention is further provided with a reinforcing edge at an appropriate position corresponding to the lock seat. When the tailgate handle reinforcement structure is attached between the two supporting posts, the reinforcing edge is closely attached to the lock seat.

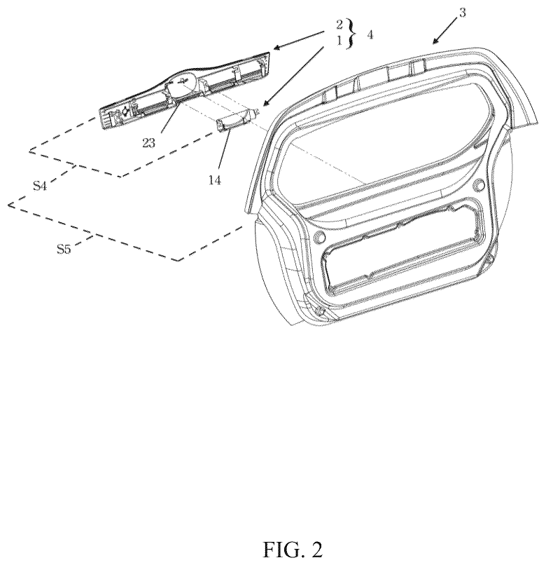

Through the reinforcing edge, the lock seat can also be reinforced. The lock seat is usually the most accessible position for users. Please refer to FIG. 2, which is the action diagram of step S4 and step S5 of the present invention. This figure reveals that the reinforcement structure of the car tailgate handle of the present invention is installed between the car tailgate handle and a car tailgate, so when the user opens the car tailgate, usually, the force application point will be between the lock seat or the two supporting posts, so the maximum value of the weight of the tailgate and the force exerted by the user will be reached at the moment when the user opens the tailgate, and the two forces will be exerted between the lock seat or the two supporting posts, and the force will also be transmitted to the keyhole contact surface, therefore the most easily damaged parts of the tailgate handle of the tailgate are the lock seat, the space between the two supporting posts and the keyhole contact surface, and the durability of the car tailgate handle can be greatly improved through the reinforcement structure body, the reinforcing edge and the reinforcing keyhole contact surface, and other redundant parts are not needed. In addition, the designs of lock seat positions of vehicle models are different, which can be adjusted as required. The essence of the present invention lies in achieving the best reinforcement effect in the simplest and easiest way to manufacture.

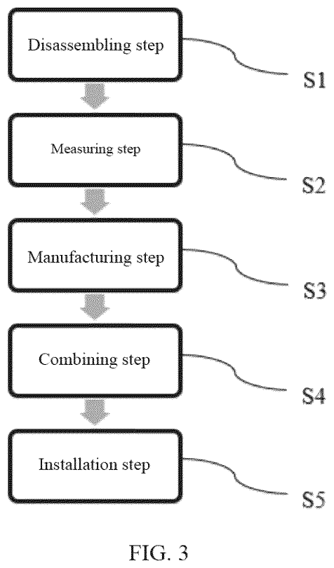

Please refer to FIG. 3, which is the step diagram of the method of the present invention, and also refer to FIG. 1, the embodiment diagram of the present invention. This figure reveals a method for reinforcing the car tailgate handle, which is designed to reinforce an easily broken car tailgate handle. Two supporting posts are protruded on the car tailgate handle, and the ends of these supporting posts are provided with a keyhole contact surface. Keyholes are formed on the keyhole contact surfaces. The reinforcement method of the car tailgate handle includes: S1 a disassembling step: disassembling the car tailgate handle so as to facilitate subsequent installation or precise measurement; S2: a measuring step: precisely measuring an each keyhole contact surface that is easy to break of the car tailgate handle, the position of each keyhole and the three-dimensional shape data of each part in the shortest linear distance between the supporting posts to be used for subsequent mold making or processing production; S3, a manufacturing step: copying and manufacturing a completely corresponding reinforcement structure according to the three-dimensional shape data, wherein the reinforcement structure has a reinforcement structure body, the shape of one side of the reinforcement structure body is consistent with the shape of the car tailgate handle between the supporting posts, and two ends of the other side of the reinforcement structure body are convexly provided with reinforcing supporting posts, and the shape of one side of the reinforcing supporting posts is consistent with the shape of one side of the supporting posts; the top ends of the reinforcing supporting posts are provided with reinforcing keyhole contact surfaces whose shape matches that of the keyhole contact surface, and the reinforcing keyhole contact surfaces are provided with reinforcing keyholes completely corresponding to the positions of the keyholes, and the car tailgate handle reinforcement structure can be attached between the two supporting posts.

Next, please refer to FIG. 2, which is the action diagram of step S4 and step S5 of the present invention. In step S4, i.e., a combining step, the reinforcement structure of the car tailgate handle is closely attached to the car tailgate handle, the reinforcing keyhole contact surfaces and the keyhole contact surfaces are closely attached to each other, and the reinforcement structure body is closely attached to the car tailgate handle between the supporting posts to form a reinforced car tailgate handle. In step S5, an installation step, the reinforced car tailgate handle is installed back to the car tailgate, and the sides of the reinforced keyhole contact surfaces facing the car body are locked on the car tailgate.

The copy manufacturing in step S2 is made by injection molding, stamping, CNC cutting or 3D printing, and the material of the car tailgate handle reinforcement structure of the present invention can be weather-resistant materials such as ABS, plastic steel, stainless steel, aluminum alloy, etc.

In addition, in step S4, there may be a gluing procedure, i.e., gluing between the two supporting posts of the tailgate handle, or painting a layer of adhesion promoter first, then applying adhesive or double-sided tape, and then tightly attaching the reinforcement structure to the tailgate handle, wherein the reinforcing keyhole contact surfaces and the keyhole contact surfaces are closely attached to each other, and the reinforcement structure body is closely attached to the tailgate handle between the supporting posts. A reinforced car tailgate handle is formed, so that a layer of buffer can be arranged in the gap between the car tailgate handle reinforcement structure and the car tailgate handle, and the car tailgate handle and the car tailgate handle reinforcement structure are bonded or clamped first, and then the installation can be quickly completed.

By the method of the present invention, when the car tailgate handle is damaged, it is not necessary to replace the whole new car tailgate handle, and the car tailgate handle and the car tailgate handle reinforcement structure can be bonded first through the gluing procedure in step S4 of the present invention, which achieves of quick repair, cost saving of maintenance and parts manufacturing, and reduced environmental pollution. As for the present invention, it can also be used for the intact car tailgate handle, which can increase the durability of the car tailgate handle after installation and make preventive upgrade. There is no need to produce a whole tailgate handle, which can reduce the pollution to the environment and the manufacturing cost, and also contribute to the sustainable development of enterprises or the earth.

What is claimed is:

1. A car tailgate handle reinforcement structure used to reinforce an easily broken car tailgate handle, wherein two supporting posts are protruded on the car tailgate handle, and the ends of the supporting posts are provided with a keyhole contact surface, and a keyhole is formed on the keyhole contact surfaces; the car tailgate handle reinforcement structure is characterized in that:
the car tailgate handle reinforcement structure has a reinforcement structure body, the shape of one surface of the reinforcement structure body is consistent with the shape of the car tailgate handle between the supporting posts, two ends of the other surface of the reinforcement structure body are provided with reinforcing supporting posts, the shape of one side surface of the reinforcing supporting posts is consistent with the shape of one side surface of the supporting posts, the top ends of the reinforcing supporting posts are provided with a reinforcing keyhole contact surface whose shape is consistent with the shape of the keyhole contact surface, and the reinforcing keyhole contact surfaces are provided with reinforcing keyholes completely corresponding to the positions of the keyholes, and the car tailgate handle reinforcement structure can be attached between the two supporting posts.

2. The car tailgate handle reinforcement structure according to claim 1, wherein the tailgate handle is further provided with a lock seat adjacent to the two supporting posts, wherein a reinforcing edge is further provided on the side of the reinforcement structure body corresponding to the lock seat, and when the tailgate handle reinforcement structure is attached between the two supporting posts, the reinforcing edge is closely attached to the lock seat.

3. The car tailgate handle reinforcement structure according to claim 1, wherein the car tailgate handle reinforcement structure is made of plastic steel.

4. The car tailgate handle reinforcement structure according to claim 1, wherein the car tailgate handle reinforcement structure is made of metal.

5. A method for reinforcing a car tailgate handle used for reinforcing an easily broken car tailgate handle, wherein two supporting posts are protruded on the car tailgate handle, and the ends of the supporting posts are provided with keyhole contact surfaces, and the keyhole contact surfaces are provided with a keyhole; the method for reinforcing the car tailgate handle comprises:
S1 a disassembling step: disassembling the car tailgate handle;
S2: a measuring step: precisely measuring a each keyhole contact surface that is easy to break of the car tailgate handle, the position of each keyhole and the three-dimensional shape data of each part in the shortest linear distance between the supporting posts;
S3, a manufacturing step: copying and manufacturing a completely corresponding reinforcement structure according to the three-dimensional shape data, wherein the reinforcement structure has a reinforcement structure body, the shape of one side of the reinforcement structure body is consistent with the shape of the car tailgate handle between the supporting posts, and two ends of the other side of the reinforcement structure body are convexly provided with reinforcing supporting posts, and the shape of one side of the reinforcing supporting posts is consistent with the shape of one side of the supporting posts; the top ends of the reinforcing supporting posts are provided with reinforcing keyhole contact surfaces whose shape matches that of the keyhole contact surface, and the reinforcing keyhole contact surfaces are provided with reinforcing keyholes completely corresponding to the positions of the keyholes, and the car tailgate handle reinforcement structure can be attached between the two supporting posts.
S4, a combining step: tightly bonding the reinforcement structure with the car tailgate handle, wherein the reinforcing keyhole contact surfaces are closely bonded with the keyhole contact surfaces, and the reinforcement structure body is closely bonded with the car tailgate handle between the keyholes to form a reinforced car tailgate handle.
S5, an installation step: installing the reinforced car tailgate handle back to the car tailgate, and the sides of the reinforcing keyhole contact surfaces facing the car body are locked on the car tailgate.

6. The method according to claim 1, wherein in S2, the copying and manufacturing is manufacturing by injection molding.

7. The method according to claim 1, wherein in S2, the copying and manufacturing is manufacturing by stamping.

8. The method according to claim 1, wherein in S2, the copying and manufacturing is manufacturing by computer numerical control (CNC) cutting.

9. The method according to claim 1, wherein in S2, the copying and manufacturing is manufacturing by 3D printing.

10. The method according to claim 1, wherein S4 further comprises a gluing procedure, namely gluing between the two supporting posts of the car tailgate handle, and then tightly attaching the reinforcement structure to the car tailgate handle, wherein the reinforcing keyhole contact surfaces are closely attached to each other, and the reinforcement structure body is closely attached to the car tailgate handle between the keyholes to form a reinforced car tailgate handle.
